(19) United States
(12) Patent Application Publication
(10) Pub. No.: US 2025/0388789 A1
(43) Pub. Date: Dec. 25, 2025

(54) Multi-Layered Device with Self-Adhering Film

(71) Applicant: Can Image Media Tech LLP, Mumbai (IN)

(72) Inventors: Ketan Desai, Mumbai (IN); Karunesh Mishra, Thane (IN)

(21) Appl. No.: 18/681,219

(22) PCT Filed: Oct. 10, 2023
(86) PCT No.: PCT/IN2023/050918

§ 371 Date: Feb. 5, 2024

(30) Foreign Application Priority Data
May 31, 2023 (IN) 202321037650

(51) Int. Cl. C09J 133/00; C09J 5/02; C09J 7/22; C09J 7/38; C09J 7/40

(52) U.S. Cl. CPC C09J 133/00; C09J 5/02; C09J 7/22; C09J 7/381; C09J 7/401; C09J 7/405; C09J 2301/122; C09J 2301/302

(57) ABSTRACT

The present invention relates to novel multi-layered device including environment friendly, PVC free and VOC free self-adhering film capable of being transferred onto diverse substrates, without the use of solvents and extensive pre-working of surfaces as is essential in conventional painting/printing applications. The multilayered device includes at least four layers, a first “Base layer” (A), a second “Release Layer” (B) on the “Base Layer” (A), a third “Pressure Sensitive Adhesive (PSA) Layer” (C) on the “Release Layer” (B), followed by a fourth “Top Coat Layer” (D) on the “PSA Layer” (C). The combination of Layers (A) and (B) forms the Release Liner [(A)(B)]. The combination of Layers (C) and (D) forms the self-adhering film [(C)(D)] of 15 GSM to 300 GSM and is separable from the Release liner [(A)(B)].

### CROSS REFERENCE TO RELATED APPLICATIONS

This application is the United States national phase of International Patent Application No. PCT/IN2023/050918 filed Oct. 10, 2023, and claims priority to Indian Patent Application No. 202321037650 filed May 31, 2023, the disclosures of which are hereby incorporated by reference in their entireties.

### BACKGROUND OF THE INVENTION

### Field of Invention

The present invention relates to novel self-adhering multi-layered device capable of being transferred onto diverse substrates, without the use of solvents and extensive pre-working of surfaces as is essential in conventional painting applications.

### Description of Related Art

Conventional painting applications require extensive treatment and working of the surfaces to be painted including long drying time for further processing. Further, several liquid paints contain Volatile Organic Compounds (VOCs) in the range of 35 ml to 100 ml per litre, which is hazardous to health and the environment. In several cases, the lingering odour of freshly painted surfaces causes allergic reactions and unpleasantness.

Wallpapers have been considered as an alternative to painting surfaces. However, Wallpapers can only be applied on selective surfaces which need to be extensively prepared prior to fixing wallpapers. Further, wallpapers are sensitive to humidity.

Vinyl-based products are extensively used in the graphic and signage industry which are not environment friendly.

There is an unmet need to provide environment-friendly products that are substitutes for painting, wallpapers, and Vinyl-based products used in the domestic, industrial, graphic & signage industries. Further, there is unmet need to provide products for such applications that can be used on diverse surfaces without the need for extensive surface preparation.

### OBJECT OF THE INVENTION

The main object of the invention is to provide multi-layered device comprising self-adhering films, that are environment-friendly, PVC free and VOC free, and transferable onto diverse surfaces, obviating the use of solvents, extensive pre-working of surfaces, substantially reducing painting time and avoiding discomfort related to lingering odour.

Yet another object of the invention is to provide the said films being capable of being printed using diverse printing inks and printing methods.

Yet another object of the invention is to provide the said multi-layered device comprising pigmented films.

Another object of the invention is to provide the said multi-layered device comprising films, transferable onto metallic, non-metallic, irrespective of the surface shape and texture surfaces.

Yet another object of the invention is to provide the said films that are washable and demonstrate water resistance.

Another object is to provide said films that conform with EN-71 Part 3.

Yet another object of the invention is to provide the said films that are transferable onto surfaces with speed thereby reducing the surface painting time substantially as compared to the time taken in conventional painting processes.

Yet another object of the invention is to provide the said films that are abrasion resistant. Yet another object of the invention is to provide the said multi-layered device that is capable of cost-effective commercial scale production and use for surface protection and decoration.

Yet another object of the invention is to provide the said multi-layered device that is easily amenable for public use as a Do-it-Yourself (DIY) product.

### SUMMARY OF THE INVENTION

According to the present invention, the multilayered device comprises at least four layers, a first “Base layer” (A), a second “Release Layer” (B) on the “Base Layer” (A), a third “Pressure Sensitive Adhesive (PSA) Layer” (C) on the “Release Layer” (B), followed by a fourth “Top Coat Layer” (D) on the “PSA Layer” (C). The combination of Layers (A) and (B) forms the Release Liner [(A)(B)]. The combination of Layers (C) and (D) forms the self-adhering film [(C)(D)] and is separable from the Release liner [(A)(B)].

The “Base Layer (A)” is a liner material typically selected from paper or plastic, The “Release Layer (B)” is preferably selected from a group of release agents, and the “PSA Layer” (C) comprises Pressure Sensitive Adhesives (PSA).

“Top Coat Layer” (D) comprises a mixture of hydrophilic & hydrophobic polymers, synthetic rubber preferably SBR, hydroxyl reactive polysilanols, and optionally pigment(s).

The ratio of hydrophilic to hydrophobic polymers is in the range of 1:0 to 1:70, preferably 1:30 to 1:60, and most preferably 1:40 to 1:50 on solids basis. In “Top Coat Layer” (D), synthetic rubber preferably SBR is 1-13% w/w of Layer (D), preferably 1-8% w/w of Layer (D), optionally pigment(s) is 15-45% w/w of Layer (D), preferably 20-25% w/w based on Layer (D), and hydroxyl reactive polysilanols 0.1-3% w/w of Layer D, preferably 0.5-1.5% w/w of Layer (D).

### BRIEF DESCRIPTION OF THE DRAWINGS

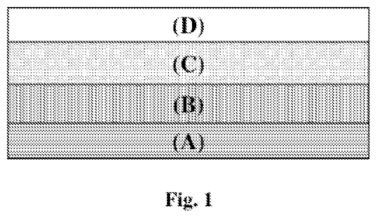

FIG. 1 shows a device comprising:
a Base Layer (A)
a Release layer (B) coated on the Layer A.
Combination of layers (A) and (B) forms the Release liner [(A)(B)].
a “Pressure Sensitive Adhesive (PSA)” layer (C) coated on the Layer (B).
a “Top Coat Layer” (D) coated on the Layer (C).
Combination of the layers (C) and (D) forms the film [(C)(D)] of 15 GSM to 300 GSM which is separable from Release liner [(A)(B)]

### DESCRIPTION OF THE INVENTION

The invention is described with reference to the accompanying drawing However, it is made clear that the description only illustrates the invention and in no way limits the same.

The terms and words used in the following description are not limited to their literal meanings. The description is representative of the illustrative embodiments and examples. The drawings and/or illustrations in no way limit the scope of the invention. It is understood that modifications and/or alterations of the drawings/illustrations of this invention other than those specifically set forth herein may be achieved by those skilled in the art and that such modifications and alterations are to be considered as falling within the overall scope of this invention.

FIG. 1 shows four layers namely:
a Base Layer (A)
a Release layer (B) coated on the Layer A.
Combination of layers (A) and (B) forms the Release liner [(A)(B)].
a “Pressure Sensitive Adhesive (PSA)” layer (C) coated on the Layer (B).
a “Top Coat Layer” (D) coated on the Layer (C).
Combination of the layers (C) and (D) forms the film [(C)(D)] of 15 GSM to 300 GSM which is separable from Release liner [(A)(B)]

Additional layers may be coated or applied in the form of varnish or waterproof coating layer, or laminating on the Film.

The layer A is a liner material, typically either paper or plastic films.

The paper in “Base Layer” (A) is selected from Super Calendered Kraft (SCK) paper, poly-coated Kraft paper, Glassine, Clay Coated Kraft (CCK) paper, Machine Finished Kraft (MFK) paper, or Machine Glazed (MG) paper.

In an embodiment wherein the “Base Layer” (A) is plastic, the plastic is selected from PET film (biaxially oriented), poly-coated BO-PET film, BOPP (biaxially oriented PP film) or other Polyolefins typically comprising HDPE, LDPE, or PP plastic resins

“Release Layer” (B) is selected from a group of silicone release agents, phosphate ester, alkylated phosphorylated esters, fluoro-polymer, preferably silicone release agents.

The pressure-sensitive adhesives in the “PSA Layer” (C) is selected from Butyl acrylate, Ethyl hexyl acrylate, Styrene Block co-polymer, Styrene-Butadiene-Styrene, Styrene-Iso prene-styrene, preferably Butyl acrylate polymer and Ethyl hexyl acrylate polymers.

“Top Coat Layer” (D) comprises a mixture of hydrophilic & hydrophobic polymers, synthetic rubber preferably SBR, hydroxyl reactive polysilanols, and optionally pigment(s). The ratio of hydrophilic to hydrophobic polymers is in the range of 1:0 to 1:70, preferably 1:30 to 1:60, and most preferably 1:40 to 1:50 on solids basis. In “Top Coat Layer” (D), synthetic rubber preferably SBR is 1-13% w/w, preferably 1-8% w/w of Layer (D), optionally pigment(s) is 15-45% w/w, preferably 20-25% w/w of Layer (D), and hydroxyl reactive polysilanols 0.1-3% w/w, preferably 0.5-1.5% w/w of Layer (D).

Hydrophilic polymer is selected from polyvinyl alcohol, polyvinyl pyrrolidone, starch, dextrin, hydroxy ethyl cellulose, hydroxy propyl cellulose, methyl hydroxyethyl cellulose, preferably polyvinyl alcohol, and polyvinyl pyrrolidone.

Hydrophobic polymer is selected from acrylic polymers emulsion/latex preferably SBR latex/polyvinyl acetate latex/styrene acrylic polymer emulsion, acrylic polymer, polyamides, epoxy resins, polyesters, and poly-olefins, and group of synthetic rubbers.

Solvents to dissolve Hydrophobic polymers are selected from groups of Ketones, Esters, Alcohols, Aromatic hydrocarbons, Ester-alcohols, and Alcohol-Ketones.

### Process for the Preparation of the Multilayer Device of the Present Invention

The process comprises steps:

### i) Preparation of the Release Liner [(A)(B)]

“Base layer” (A) is coated with a release agent to obtain the “Release Layer” (B) and dried at 160° C. to 180° C.

### ii) Coating of the “Release Liner” [(A)(B)] With the “PSA Layer” (C)

The “Release Liner” [(A)(B)] is coated with a Pressure sensitive adhesive (PSA) to achieve 5 to 30 GSM and dried at 120° C. to 140° C. Optionally pigment(s) may be added to obtain a coloured back layer.
   iii) Coating of the “Release Liner” [(A)(B)] Coated With “PSA Layer” (C) Further With “Top Coat Layer” (D)
“Top Coat Layer” (D) is prepared and then coated on the “PSA Layer” (C) in steps:
a) An acrylic emulsion polymer/polymer solution is stirred at high speed preferably at 800 to 1000 rpm,
b) A dispersing agent is added to the acrylic emulsion/polymer solution under stirring followed by optional addition of titanium dioxide (Rutile) and optionally coloured fine pastes. under stirring to achieve homogenization,
c) An solution of hydrophilic polymers is added to the above mixture under stirring, followed by sequential addition of synthetic rubber preferably SBR and hydroxyl reactive polysilanols under stirring, optionally mixing defoamer, flow & levelling agent, and dry-film preservatives, and removing extraneous matter if any to obtain a “coating dope”,
d) Coating the “PSA Layer” (C) with the “coating dope” of step (c) and drying at 120° C. to 130° C. to achieve the Film [(C)(D)] of 15 to 300 GSM,
e) Optionally coating additional layers on the Film [(C)(D)], in the form of varnish or waterproofing or lamination.

The invention is illustrated with non-limiting examples

### Example-1

### Multi-Layer Devices With Self-Adhering Film [(C)(D)]

i) 90 GSM CCK (Clay Coated Kraft) paper was taken (“Base Layer” (A)) and coated with silicone {“Release Layer” (B)} and dried at 170 to 180° C. to obtain a “Release Layer” (B) weight of 1.0 to 1.5 GSM. This silicone-coated CCK paper was used as “Release Liner” [(A)(B)]
ii) Pressure Sensitive Adhesive (BONDEX ACR) 18 grams per square meter was applied over the “Release Layer” (B) and dried at 120-130° C. to achieve “PSA Layer” (C) on “Release Layer” (B).
iii) A “coating dope” was prepared as follows:
   Acrylic polymer emulsion (54% Solids content) was taken in mixing pot and 0.4% dispersing agent was added, under high-speed mixing, based on total batch charge, followed by addition of titanium dioxide that is 15% of total solids content of batch charged and 0.9% of pigment blue paste (Pigment Blue CI 15:3) was added for getting desired shade.
   After that polyvinyl alcohol (13.5% solution in water) was added to get PVA: acrylic polymer ratio of 1:44.5.
   After that 4% SBR Latex and 2.5% hydroxyl reactive polysilanols were added under continuous mixing, based on total charge.
   In continuation 0.3% of Defoamer & 0.3% of Flow & levelling agent were added, based on total charge to get smooth & uniform mass.
   It was filtered to obtain a coating dope.
iv) The coating dope was applied on “PSA Layer” (C) and dried at 120-130° C. to obtain “Top Coat Layer” (D) with GSM of 110-120, and the film [(C)(D)] of GSM 130-140.

### Example-2

### Multi-Layer Devices With Self-Adhering Film [(C)(D)]

i. 90 GSM CCK (Clay Coated Kraft) paper was taken (“Base Layer” (A)) and coated with silicone (“Release Layer” (B)) and dried at 170 to 180° C. to obtain a “Release Layer” (B) weight of 1.0 to 1.5 GSM. This silicone-coated CCK paper was used as “Release Liner” [(A)(B)]
ii. Pressure Sensitive Adhesive (BONDEX ACR) 18 grams per square meter was applied over the “Release Layer” (B) and dried at 120-130° C. to achieve “PSA Layer” (C) on “Release Layer” (B).
iii. A “coating dope” was prepared as follows:
   Acrylic polymer emulsion (54% Solids content) was taken in mixing pot and 0.4% dispersing agent was added, under high-speed mixing, based on total batch charge, followed by addition of titanium dioxide that is 25% of total solids content of batch charged.
   After that polyvinyl pyrrolidone PVPK-30 (40% solution in water) was added to get PVPK: acrylic polymer ratio of 1:33.75.
   After that 3% SBR Latex and 2% hydroxyl reactive polysilanols were added under continuous mixing, based on total charge.
   In continuation 0.3% of defoamer & 0.3% of flow & levelling agent were added, followed by 0.7% addition of dry film preservative based on total charge and further mixing for 15 minutes to get smooth & uniform mass.
   It was filtered to obtain a coating dope.
iv. The coating dope was applied on “PSA Layer” (C) and dried at 120-130° C. to obtain “Top Coat Layer” (D) with GSM of 120-130, and the film [(C)(D)] of GSM 140-150.

### Example-3

### Multi-Layer Devices With Self-Adhering Film [(C)(D)]

a. 90 GSM CCK (Clay Coated Kraft) paper was taken (“Base Layer” (A)) and coated with silicone (“Release Layer” (B)) and dried at 170 to 180° C. to obtain a “Release Layer” (B) weight of 1.0 to 1.5 GSM. This silicone-coated CCK paper was used as “Release Liner” [(A)(B)]
b. Pressure Sensitive Adhesive (BONDEX ACR) 20 grams per square meter was applied over the “Release Layer” (B) and dried at 120-130° C. to achieve “PSA Layer” (C) on “Release Layer” (B).
c. A “coating dope” was prepared as follows:
   Acrylic polymer emulsion (54% Solids content) was taken in mixing pot and 0.4% dispersing agent was added, under high-speed mixing, based on total batch charge, followed by addition of Titanium dioxide that is 23% of total solids content of batch charged.
   After that polyvinyl alcohol (13.5% solution in water) was added to get PVA: acrylic polymer ratio of 1:20. After that 2.8% SBR Latex and 1% hydroxyl reactive polysilanols were added under continuous mixing, based on total charge.
   In continuation 0.3% of Defoamer & 0.3% of flow & levelling agent were added, based on total charge to get smooth & uniform mass.
   It was filtered to obtain a coating dope.
d. The coating dope was applied on “PSA Layer” (C) and dried at 120-130° C. to obtain “Top Coat Layer” (D) with GSM of 110-120, and the film [(C)(D)] of GSM 130-140.

### Example-4

### Multi-Layer Devices With Self-Adhering Film [(C)(D)]

a. 90 GSM CCK (Clay Coated Kraft) paper was taken (“Base Layer” (A)) and coated with silicone (“Release Layer” (B)) and dried at 170 to 180° C. to obtain a “Release Layer” (B) weight of 1.0 to 1.5 GSM. This silicone-coated CCK paper was used as “Release Liner” [(A)(B)]
b. Pressure Sensitive Adhesive (BONDEX ACR) 20 grams per square meter was applied over the “Release Layer” (B) and dried at 120-130° C. to achieve “PSA Layer” (C) on “Release Layer” (B).
c. A “coating dope” was prepared as follows:
   Acrylic polymer solution (50% solids content) was taken in a mixing pot, and 0.4% of dispersing agent was added under high-speed mixing followed by the addition of 20% of titanium dioxide (ATR 312, Rutile) paste (75% solids) based on the solid content of batch charge, 3.0% of SBR and 2.0% of hydroxyl reactive polysilanols) based on total batch charge.
   Mixing was continued and PVPK-30 (Polyvinyl Pyrrolidone K-30) solution (30% solids content) was added under mixing, keeping PVPK: acrylic polymer ratio 1:45, followed by addition of 0.8% of dry film preservative and mixed for 10 minutes. It was filtered to obtain “coating dope”.
   d. The “coating dope” was used to coat “PSA Layer” (C) and dried at 120-130° C. to achieve a coating of 90-100 GSM of “Top Coat Layer” (D) resulting in a total film [(C)(D)] GSM of 110-120.

### Application of the Multi-Layered Device of the Present Invention

a. cleaning the surface of the substrate on which the film [(C)(D)] is to be transferred,
b. peeling the film [(C)(D)] from the “Release Liner” [(A)(B)],
c. laying the adhesive side of the film [(C)(D)] on the said substrate surface on which the film is to be transferred,
d. applying pressure on the film, to adhere onto the said surface,
e. removing bubbles if any between the transferred film and the surface by known methods.

### ADVANTAGES

In addition to overcoming the drawbacks in the existing products, technologies, and practices related to the paint industry, the present invention provides multi-layered device comprising printable self-adhering films, exhibits significant benefits as they are:

1. Environment-friendly, PVC free and VOC free, transferable onto any surface, obviating the use of solvents, extensive pre-working of surfaces, substantially reducing painting time, avoiding issues related to lingering paint odour while conforming with EN-71 Part 3.
2. transferable onto metallic, non-metallic, for example, wall, ply, metal, tile, glass, wood, stone, cement, or plastic, irrespective of the surface shape and texture of the substrate.
3. capable of being loaded with pigment(s) and/or printed using diverse printing inks and printing methods.
4. washable and demonstrate water resistance.
5. capable of cost-effective commercial scale production and use for surface protection and decoration.
6. easily amenable for public use as a Do-it-Yourself (DIY) product.
7. capable for use in painting interior walls in residential & commercial establishments, printed graphic applications, advertising, promotions, labels, and other marketing campaigns, and surface coverings.

1. A Multi-layered Device with Self-Adhering Film comprising a Base Layer (A), a Release layer (B) coated on the Layer A, combination of layers (A) and (B) forming a Release liner [(A)(B)], a “Pressure Sensitive Adhesive (PSA)” layer (C) coated on the Layer (B) and a “Top Coat Layer” (D) coated on the Layer (C), combination of the layers (C) and (D) forming a film [(C)(D)] which is separable from Release liner [(A)(B)], wherein the Layer (D) comprises hydrophobic polymers and hydrophilic polymers.

2. The self-adhering multi-layered device claimed in claim 1, with additional layers coated or applied in the form of varnish or waterproof coating layer, or laminating on the Film [(C)(D)].

3. A process for the preparation of the self-adhering multi-layered device claimed in claim 1 comprising steps:
i. coating a “Base layer” (A) with a release agent to obtain a “Release Layer” (B) and drying (at 160° C. to 180° C.), to obtain a “Release Liner” [(A)(B)];
ii. coating the top surface of the Release Layer (B) of the Release Liner [(A)(B)] with a Pressure-Sensitive Adhesive (PSA) and drying at 120° C. to 140° C. to obtain a PSA Layer (C),
iii. coating the top surface of the PSA layer (C) with a “coating dope” to obtain a “Top Coat Layer” (D) in steps:
a) adding a dispersing agent under stirring to a hydrophobic polymer emulsion/solution, followed by optional addition of titanium dioxide (Rutile) and/or pigment(s) under stirring,
b) adding solution of hydrophilic polymer to the mixture in step (a), followed by sequential addition of synthetic rubber, preferably SBR and hydroxyl reactive polysilanols under stirring, optionally mixing defoamer, flow & levelling agent, and dry-film preservatives, and removing extraneous matter if any to obtain a “coating dope”,
c) coating the top surface of the PSA layer (C) with the “coating dope” of step (b), drying at 120° C. to 130° C. to obtain a “Top Coat Layer” (D), the combination of Layers (C) and (D) forming “Film” [(C)(D)], and
d) optionally coating additional layers on the Film [(C)(D)], in the form of varnish or waterproofing or lamination.

4. The “Base Layer (A)” claimed in claim 1, is a liner material selected from paper such as Super Calendered Kraft (SCK) paper, poly-coated Kraft paper, Glassine, Clay Coated Kraft (CCK) paper, Machine Finished Kraft (MFK) paper, or Machine Glazed (MG) paper.

5. The “Base Layer (A)” claimed in claim 1, is a liner material selected from plastics such as PET film (biaxially oriented), poly-coated BO-PET film, BOPP (biaxially oriented PP film) or other Polyolefins typically comprising HDPE, LDPE or PP plastic resins.

6. The “Release Layer (B)” as claimed in claim 1, is selected from a group of silicone release agents, phosphate ester, alkylated phosphorylated esters, fluoro-polymer, preferably silicone release agents.

7. The pressure-sensitive adhesives in the “PSA Layer” (C) claimed in claim 1, is selected from Butyl acrylate, Ethyl hexyl acrylate, Styrene Block co-polymer, Styrene-Butadiene-Styrene, Styrene-Isoprene-styrene, preferably Butyl acrylate polymer and Ethyl hexyl acrylate polymers.

8. The “Top Coat Layer” (D) claimed in claim 1, comprises a mixture of hydrophilic & hydrophobic polymers in the ratio of 1:0 to 1:70, preferably 1:30 to 1:60, and most preferably 1:40 to 1:50 on solids basis, synthetic rubber preferably SBR in the range 1-13% w/w, preferably 1-8% w/w of Layer (D), optionally pigment in the range 15-45% w/w, preferably 20-25% w/w of Layer (D), and hydroxyl reactive polysilanols in the range 0.1-3% w/w, preferably 0.5-1.5% w/w of Layer (D).

9. The hydrophilic polymer in the “Top Coat Layer” (D) as claimed in claim 1, is selected from polyvinyl alcohol, polyvinyl pyrrolidone, starch, dextrin, hydroxy ethyl cellulose, hydroxy propyl cellulose, methyl hydroxyethyl cellulose, preferably polyvinyl alcohol, and polyvinyl pyrrolidone.

10. The hydrophobic polymer in the “Top Coat Layer” (D) as claimed in claim 1, is selected from acrylic polymers emulsion/latex preferably SBR latex/polyvinyl acetate latex/styrene acrylic polymer emulsion, preferably styrene-acrylic polymer emulsion, acrylic polymer, polyamides, epoxy resins, polyesters, and poly-olefins, and group of synthetic rubbers.

11. The “PSA Layer (C) as claimed in claim 1, is in the range 5 to 30 GSM.

12. The film [(C)(D)] as claimed in claim 13, is in the range 15 GSM to 300 GSM.

13. The multi-layered device as claimed in claim 1, comprising washable, water resistant, self-adhering films that transferable onto any surface.

14. The multi-layered device as claimed in claim 1, is environment friendly, PVC free and VOC free.

15. A process for the application of the films [(C)(D)] of the multi-layered device as claimed in claim 1, on any metallic or non-metallic surfaces, irrespective of the surface shape and texture, comprises steps:
a. cleaning the surface of the substrate on which the film [(C)(D)] is to be transferred,
b. peeling the film [(C)(D)] from the “Release Liner” [(A)(B)],
c. laying the adhesive side of the film [(C)(D)] on the said substrate surface on which the film is to be transferred,
d. applying pressure on the film, to adhere onto the said surface, and
e. removing bubbles if any between the transferred film and the surface by known methods.
